(19) United States
(12) Patent Application Publication
(10) Pub. No.: US 2015/0055482 A1
(43) Pub. Date: Feb. 26, 2015

(54) TCP Extended Fast Recovery and Segment Timing

(71) Applicant: Brocade Communications Systems, Inc., San Jose, CA (US)

(72) Inventors: Isaac Larson, Bangalore, MN (US); Andy Dooley, Rogers, MN (US); Maulik Patel, Bangalore (IN)

(21) Appl. No.: 14/066,837

(22) Filed: Oct. 30, 2013

Related U.S. Application Data
(60) Provisional application No. 61/867,787, filed on Aug. 20, 2013.

(51) Int. Cl. H04L 1/08; H04L 12/26

(52) U.S. Cl. CPC H04L 1/08; H04L 43/0841
USPC 370/242

(57) ABSTRACT

When in Fast Recovery, Extended Fast Recovery operation starts a timer on the retransmission of each packet. The time expires in one adjusted round trip time. If there has not been an acknowledgement for the retransmitted packet and the Extended Fast Recovery timer expires, it is assumed that the retransmitted packet was lost and must be retransmitted again. Extended Fast Recovery operation keeps retransmitting the packet, once every adjusted round trip time, until an acknowledgement is received or the slow recovery timer expires. Segment Timing is an addition to Extended Fast Recovery where every sent packet is timed separately from the time of first transmission, not just retransmitted packets.

### CROSS REFERENCE TO RELATED APPLICATIONS

This application claims the benefit under 35 U.S.C. §119(e) of U.S. Provisional Patent Application Ser. No. 61/867,787, entitled “TCP Extended Fast Recovery and Segment Timing,” filed Aug. 20, 2013, which is hereby incorporated by reference.

### BACKGROUND OF THE INVENTION

1. Field of the Invention

The invention relates to network transmission using the TCP protocol.

2. Description of the Related Art

A storage area network (SAN) may be implemented as a high-speed, special purpose network that interconnects different kinds of data storage devices with associated data servers on behalf of a large network of users. Typically, a storage area network includes high performance switches as part of the overall network of computing resources for an enterprise. The storage area network is usually clustered in close geographical proximity to other computing resources, such as mainframe computers, but may also extend to remote locations for backup and archival storage using wide area network carrier technologies. Fibre Channel networking is typically used in SANs although other communications technologies may also be employed, including Ethernet and IP-based storage networking standards (e.g., iSCSI, FCIP (Fibre Channel over Internet Protocol), etc.).

As used herein, the term “Fibre Channel” refers to the Fibre Channel (FC) family of standards (developed by the American National Standards Institute (ANSI)) and other related and draft standards. In general, Fibre Channel defines a transmission medium based on a high speed communications interface for the transfer of large amounts of data via connections between varieties of hardware devices.

FC standards have defined limited allowable distances between FC switch elements. Fibre Channel over IP (FCIP) refers to mechanisms that allow the interconnection of islands of FC SANs over IP-based (internet protocol-based) networks to form a unified SAN in a single FC fabric, thereby extending the allowable distances between FC switch elements to those allowable over an IP network. For example, FCIP relies on IP-based network services to provide the connectivity between the SAN islands over local area networks (LANs), metropolitan area networks (MANs), and wide area networks (WANs). Accordingly, using FCIP, a single FC fabric can connect physically remote FC sites allowing remote disk access, tape backup, and live mirroring.

In an FCIP implementation, FC traffic is carried over an IP network through a logical FCIP tunnel. Each FCIP entity on either side of the IP network works at the session layer of the OSI model. The FC frames from the FC SANs are encapsulated in IP packets and transmission control protocol (TCP) segments and transported in accordance with the TCP layer in one or more TCP sessions. For example, an FCIP tunnel is created over the IP network and a TCP session is opened in the FCIP tunnel.

One common problem in TCP/IP networks is packet loss. Each packet must be acknowledged. Usually this is done sequentially as the packets arrive, but in certain cases packets may be lost or corrupted and following packets received correctly.

While Standard TCP has fast recovery mechanisms to quickly recover from packet loss on a network, they have some limitations when multiple packet loss has occurred. Multiple packet loss is defined as when the first transmission of a packet has been lost and then when one or more of the subsequent retransmissions of the same packet are also lost. With Standard TCP if the fast recovery mechanism fails to recover in the multiple loss scenario, it will resort to a slow recovery mechanism. The slow recovery mechanism will dramatically reduce the overall throughput of the connection.

One approach to address this issue is a mechanism called re-SACK. The re-SACK mechanism tries to describe multiple loss (transmitter to receiver) to the transmitter with the order of information in the Standard TCP SACK optional header. This mechanism is reliant, however, on this information not being lost in the opposite direction (receiver to transmitter). If this re-SACK information packet is lost as well, there will be no recovery of this information and slow recovery is the last resort. This is described in more detail in U.S. patent application Ser. No. 12/972,713, entitled “Repeated Lost Packet Retransmission in a TCP/IP Network,” filed Dec. 20, 2010, hereby incorporated by reference.

### SUMMARY OF THE INVENTION

Once in Fast Recovery, Extended Fast Recovery operation starts a timer on the retransmission of each packet. The time expires in one adjusted round trip time. If there has not been an acknowledgement for the retransmitted packet and the Extended Fast Recovery timer expires, it is assumed that the retransmitted packet was lost and must be retransmitted again. Extended Fast Recovery operation keeps retransmitting the packet, once every adjusted round trip time, until an acknowledgement is received or the slow recovery timer expires. Segment Timing is an addition to Extended Fast Recovery where every sent packet is timed separately from the time of first transmission, not just retransmitted packets.

### BRIEF DESCRIPTION OF THE FIGURES

The accompanying drawings, which are incorporated in and constitute a part of this specification, illustrate an implementation of apparatus and methods consistent with the present invention and, together with the detailed description, serve to explain advantages and principles consistent with the invention.

FIG. 1 illustrates an example FCIP configuration using distinct per-priority TCP sessions within a single FCIP tunnel over an IP network.

FIG. 2 illustrates example IP gateway devices communicating over an IP network using distinct per priority TCP sessions within a single FCIP.

FIG. 3A illustrates a logical block diagram of portions of a transmitter TCP/IP interface according to the present invention.

FIG. 3B illustrates a logical block diagram of portions of a receiver TCP/IP interface according to the present invention.

FIGS. 4A-4D are flowcharts of Extended Fast Recovery according to the present invention.

FIGS. 5A-5D are flowcharts of Segment Timing according to the present invention.

FIG. 6 is a flowchart of round trip measurement according to the present invention.

### DETAILED DESCRIPTION OF THE PREFERRED EMBODIMENTS

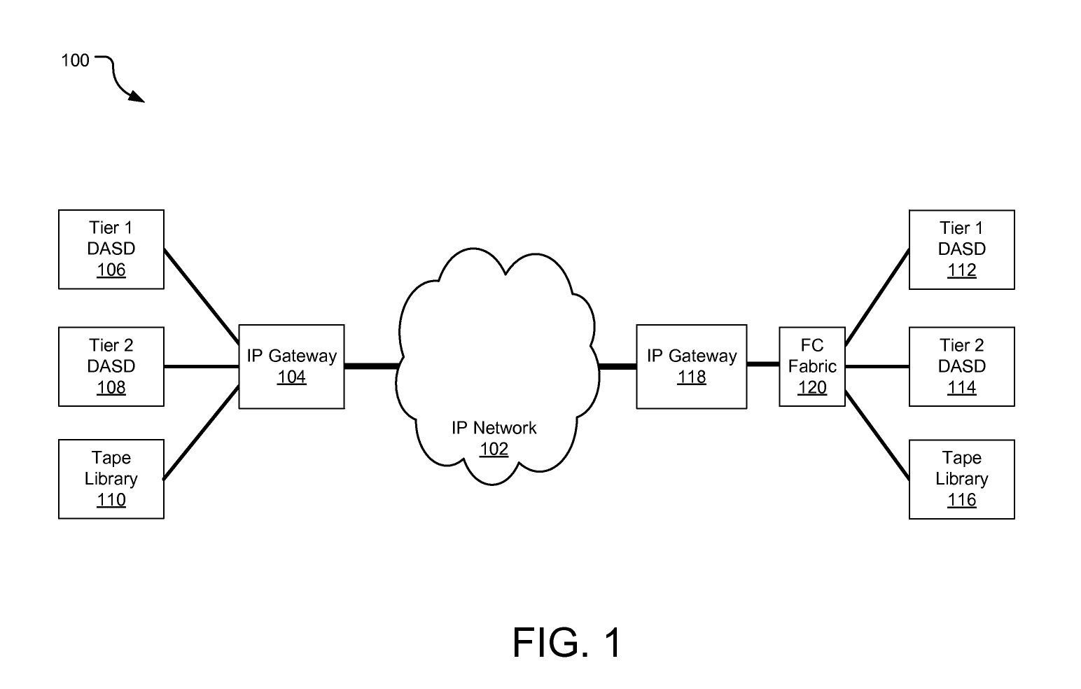

FIG. 1 illustrates an example FCIP configuration 100 using distinct per-priority TCP sessions within a single FCIP tunnel over an IP network 102. An IP gateway device 104 (e.g., an FCIP extender), couples example FC source nodes (e.g., Tier 1 Direct Access Storage Device (DASD) 106, Tier 2 DASD 108, and a tape library 110) to the IP network 102 for communication to example FC destination nodes (e.g., Tier 1 DASD 112, Tier 2 DASD 114, and a tape library 116, respectively) through an IP gateway device 118 (e.g., another FCIP extender) and an FC fabric 120. Generally, an IP gateway device interfaces to an IP network. In the specific implementation illustrated in FIG. 1, the IP gateway device 118 interfaces between an IP network and an FC fabric, but other IP gateway devices may include tape extension devices, Ethernet network interface controllers (NICs), host bus adapters (HBAs), and director level switches). An example application of such an FCIP configuration would be a remote data replication (RDR) scenario, wherein the data on the Tier 1 DASD 106 is backed up to the remote Tier 1 DASD 112 at a high priority, the data on the Tier 2 DASD 108 is backed up to the remote Tier 2 DASD 114 at a medium priority, and data on the tape library no is backed up to the remote tape library 116 at a low priority. In addition to the data streams, a control stream is also communicated between the IP gateway devices 104 and 118 to pass class-F control frames.

The IP gateway device 104 encapsulates FC packets received from the source nodes 106, 108, and 110 in TCP segments and IP packets and forwards the TCP/IP-packet-encapsulated FC frames over the IP network 102. The IP gateway device 118 receives these encapsulated FC frames from the IP network 102, “de-encapsulates” them (i.e., extracts the FC frames from the received IP packets and TCP segments), and forwards the extracted FC frames through the FC fabric 120 to their appropriate destination nodes 112, 114, and 116. It should be understood that each IP gateway device 104 and 118 can perform the opposite role for traffic going in the opposite direction (e.g., the IP gateway device 118 doing the encapsulating and forwarding through the IP network 102 and the IP gateway device 104 doing the de-encapsulating and forwarding the extracted FC frames through an FC fabric). In other configurations, an FC fabric may or may not exist on either side of the IP network 102. As such, in such other configurations, at least one of the IP gateway devices 104 and 118 could be a tape extender, an Ethernet NIC, etc.

Each IP gateway device 104 and 118 includes an IP interface, which appears as an end station in the IP network 102. Each IP gateway device 104 and 118 also establishes a logical FCIP tunnel through the IP network 102. The IP gateway devices 104 and 118 implement the FCIP protocol and rely on the TCP layer to transport the TCP/IP-packet-encapsulated FC frames over the IP network 102. Each FCIP tunnel between two IP gateway devices connects two TCP end points in the IP network 102. Viewed from the FC perspective, pairs of switches export virtual E_PORTs or virtual EX_PORTs (collectively referred to as virtual E_PORTs) that enable forwarding of FC frames between FC networks, such that the FCIP tunnel acts as an FC InterSwitch Link (ISL) over which encapsulated FC traffic flows.

The FC traffic is carried over the IP network 102 through the FCIP tunnel between the IP gateway device 104 and the IP gateway device 118 in such a manner that the FC fabric 102 and all purely FC devices (e.g., the various source and destination nodes) are unaware of the IP network 102. As such, FC datagrams are delivered in such time as to comply with applicable FC specifications.

To accommodate multiple levels of priority, the IP gateway devices 104 and 118 create distinct TCP sessions for each level of priority supported, plus a TCP session for a class-F control stream. In one implementation, low, medium, and high priorities are supported, so four TCP sessions are created between the IP gateway devices 104 and 118, although the number of supported priority levels and TCP sessions can vary depending on the network configuration. The control stream and each priority stream is assigned its own TCP session that is autonomous in the IP network 102, getting its own TCP stack and its own settings for VLAN Tagging (IEEE 802.1Q), quality of service (IEEE 802.1P) and Differentiated Services Code Point (DSCP). Furthermore, the traffic flow in each per priority TCP session is enforced in accordance with its designated priority by an algorithm, such as but not limited to a deficit weighted round robin (DWRR) scheduler. All control frames in the class-F TCP session are strictly sent on a per service interval basis.

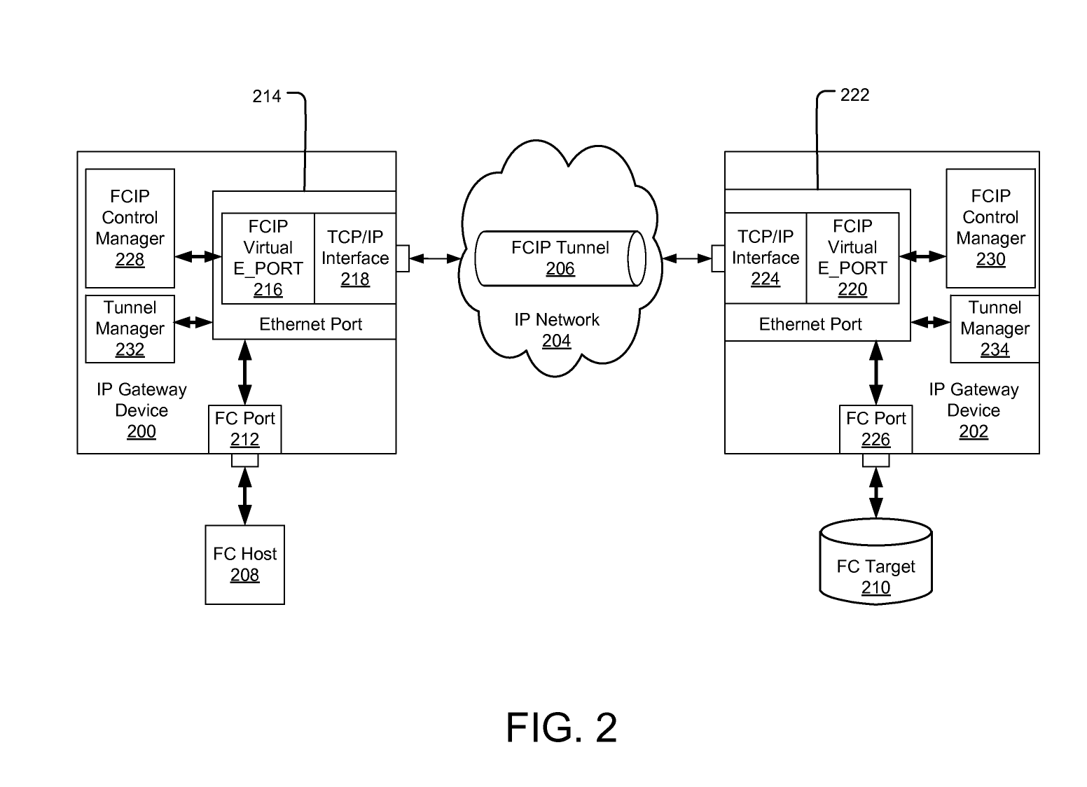

FIG. 2 illustrates example IP gateway devices 200 and 202 (e.g., FCIP extension devices) communicating over an IP network 204 using distinct per priority TCP sessions within a single FCIP tunnel 206. An FC host 208 is configured to send data to an FC target 210 through the IP network 204. It should be understood that other data streams between other FC source devices (not shown) and FC target devices (not shown) can be communicated at various priority levels over the IP network 204.

The FC host 208 couples to an FC port 212 of the IP gateway device 200. The coupling may be made directly between the FC port 212 and the FC host 208 or indirectly through an FC fabric (not shown). The FC port 212 receives FC frames from the FC host 208 and forwards them to an Ethernet port 214, which includes an FCIP virtual E_PORT 216 and a TCP/IP interface 218 coupled to the IP network 204. The FCIP virtual E_PORT 216 acts as one side of the logical ISL formed by the FCIP tunnel 206 over the IP network 204. An FCIP virtual E_PORT 220 in the IP gateway device 202 acts as the other side of the logical ISL. The Ethernet port 214 encapsulates each FC frame received from the FC port 212 in a TCP segment belonging to the TCP session for the designated priority and an IP packet shell and forwards them over the IP network 204 through the FCIP tunnel 206.

The FC target 210 couples to an FC port 226 of the IP gateway device 202. The coupling may be made directly between the FC port 226 and the FC host 210 or indirectly through an FC fabric (not shown). An Ethernet port 222 receives TCP/IP-packet-encapsulated FC frames over the IP network 204 from the IP gateway device 200 via a TCP/IP interface 224. The Ethernet port 222 de-encapsulates the received FC frames and forwards them to an FC port 226 for communication to the FC target device 210.

It should be understood that data traffic can flow in either direction between the FC host 208 and the FC target 210. As such, the roles of the IP gateway devices 200 and 202 may be swapped for data flowing from the FC target 210 and the FC host 208.

Tunnel manager modules 232 and 234 (e.g., circuitry, firmware, software or some combination thereof) of the IP gateway devices 200 and 202 set up and maintain the FCIP tunnel 206. Either IP gateway device 200 or 202 can initiate the FCIP tunnel 206, but for this description, it is assumed that the IP gateway device 200 initiates the FCIP tunnel 206. After the Ethernet ports 214 and 222 are physically connected to the IP network 204, data link layer and IP initialization occur. The TCP/IP interface 218 obtains an IP address for the IP gateway device 200 (the tunnel initiator) and determines the IP address and TCP port numbers of the remote IP gateway device 202. The FCIP tunnel parameters may be configured manually, discovered using Service Location Protocol Version 2 (SLPv2), or designated by other means. The IP gateway device 200, as the tunnel initiator, transmits an FCIP Special Frame (FSF) to the remote IP gateway device 202. The FSF contains the FC identifier and the FCIP endpoint identifier of the IP gateway device 200, the FC identifier of the remote IP gateway device 202, and a 64-bit randomly selected number that uniquely identifies the FSF. The remote IP gateway device 202 verifies that the contents of the FSF match its local configuration. If the FSF contents are acceptable, the unmodified FSF is echoed back to the (initiating) IP gateway device 200. After the IP gateway device 200 receives and verifies the FSF, the FCIP tunnel 206 can carry encapsulated FC traffic.

The TCP/IP interface 218 creates multiple TCP sessions through the single FCIP tunnel 206. In the illustrated implementation, three or more TCP sessions are created in the single FCIP tunnel 206. One TCP connection is designated to carry control data (e.g., class-F data), and the remaining TCP sessions are designated to carry data streams having different levels of priority. For example, considering a three priority QoS scheme, four TCP sessions are created in the FCIP tunnel 206 between the IP gateway device 200 and the IP gateway device 202, one TCP session designated for control data, and the remaining TCP sessions designated for high, medium, and low priority traffic, respectively. Note: It should be understood that multiple TCP sessions designated with the same level of priority may also be created (e.g., two high priority TCP sessions) within the same FCIP tunnel.

The FCIP tunnel 206 maintains frame ordering within each priority TCP flow. The QoS enforcement engine may alter the egress transmission sequence of flows relative to their ingress sequence based on priority. However, the egress transmission sequence of frames within an individual flow will remain in the same order as their ingress sequence to that flow. Because the flows are based on FC initiator and FC target, conversational frames between two FC devices will remain in proper sequence. A characteristic of TCP is to maintain sequence order of bytes transmitted before deliver to upper layer protocols. As such, the IP gateway device at the remote end of the FCIP tunnel 206 is responsible for reordering data frames received from the various TCP sessions before sending them up the communications stack to the FC application layer. Furthermore, in one implementation, each TCP session can service as a backup in the event a lower (or same) priority TCP session fails. Each TCP session can be routed and treated independently of others via autonomous settings for VLAN and Priority Tagging and/or DSCP.

In addition to setting up the FCIP tunnel 206, the IP gateway device 200 may also set up TCP trunking through the FCIP tunnel 206. TCP trunking allows the creation of multiple FCIP connections within the FCIP tunnel 206, with each FCIP connection connecting a source-destination IP address pair. In addition, each FCIP connection can maintain multiple TCP sessions, each TCP session being designated for different priorities of service. As such, each FCIP connection can have different attributes, such as IP addresses, committed rates, priorities, etc., and can be defined over the same Ethernet port or over different Ethernet ports in the IP gateway device. The trunked FCIP connections support load balancing and provide failover paths in the event of a network failure, while maintaining in-order delivery. For example, if one FCIP connection in the TCP trunk fails or becomes congested, data can be redirected to a same-priority TCP session of another FCIP connection in the FCIP tunnel 206. The IP gateway device 202 receives the TCP/IP-packet-encapsulated FC frames and reconstitutes the data streams in the appropriate order through the FCIP virtual E_PORT 220. These variations are described in more detail below.

Each IP gateway device 200 and 202 includes an FCIP control manager (see FCIP control managers 228 and 230), which generate the class-F control frames for the control data stream transmitted through the FCIP tunnel 206 to the FCIP control manager in the opposing IP gateway device. Class-F traffic is connectionless and employs acknowledgement of delivery or failure of delivery. Class-F is employed with FC switch expansion ports (E PORTS) and is applicable to the IP gateway devices 200 and 202, based on the FCIP virtual E_PORT 216 and 220 created in each IP gateway device. Class-F control frames are used to exchange routing, name service, and notifications between the IP gateway devices 200 and 202, which join the local and remote FC networks into a single FC fabric. However, the described technology is not limited to combined single FC fabrics and is compatible with FC routed environments.

The IP gateway devices 200 and 202 emulate raw FC ports (e.g., VE_PORTs or VEX_PORTs) on both of the FCIP tunnel 206. For FC I/O data flow, these emulated FC ports support ELP (Exchange Link Parameters), EFP (Exchange Fabric Parameters, and other FC-FS (Fibre Channel-Framing and Signaling) and FC-SW (Fibre Channel-Switched Fabric) protocol exchanges to bring the emulated FC E_PORTs online. After the FCIP tunnel 206 is configured and the TCP sessions are created for an FCIP connection in the FCIP tunnel 206, the IP gateway devices 200 and 202 will activate the logical ISL over the FCIP tunnel 206. When the ISL has been established, the logical FC ports appear as virtual E_PORTs in the IP gateway devices 200 and 202. For FC fabric services, the virtual E_PORTs emulate regular E_PORTs, except that the underlying transport is TCP/IP over an IP network, rather than FC in a normal FC fabric. Accordingly, the virtual E_PORTs 216 and 220 preserve the “semantics” of an E_PORT.

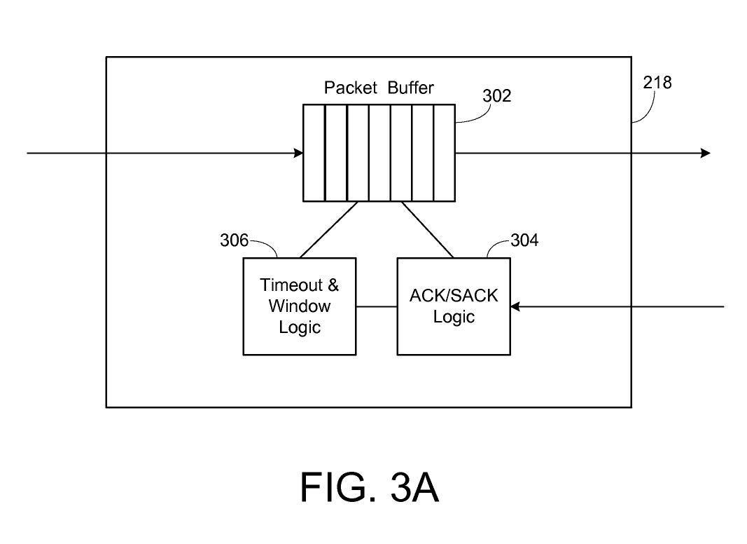

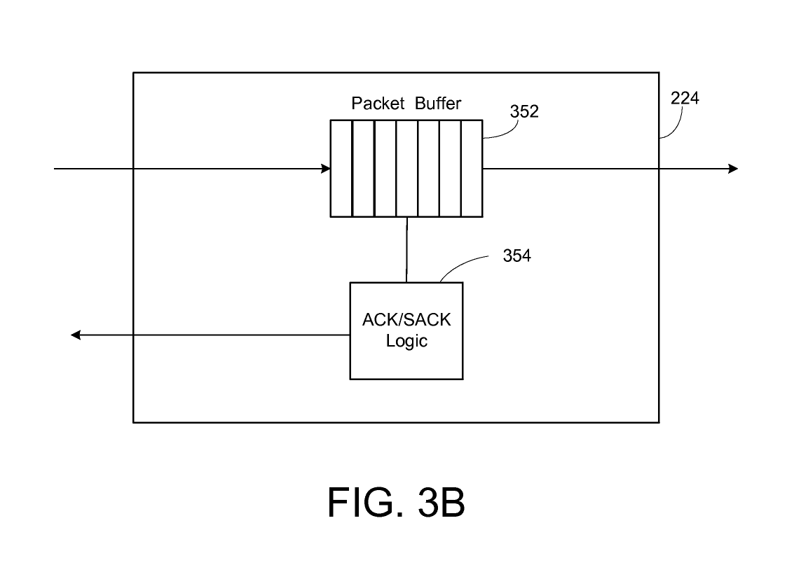

FIG. 3A is a logical block diagram of portions of the transmitter TCP/IP interface 218 according to the preferred embodiment. It is noted that this is a logical representation and actual embodiments may implemented differently, either in hardware, software or a combination thereof. A packet buffer 302 holds a series of TCP/IP packets to be transmitted. As is normal practice in TCP, the packets are not removed from the buffer until either an ACK for that packet is received or the packet times out. A ACK/SACK logic block 304 is connected to the packet buffer 302 and receives ACKs and SACKs from the IP network. The ACK/SACK logic block 304 is responsible for directing packets be removed from the packet buffer 302, such as by setting a flag so that the packet buffer 302 hardware can remove the packet. A timeout logic module 306 is connected to the packet buffer 302 and the ACK/SACK logic module 304. The timeout logic module 306 monitors the period each of the TCP/IP packets have been in the packet buffer 302 so that after the timeout period, as well known to those skilled in the art, timeout operations can proceed based on the particular TCP/IP packet being considered lost or otherwise not able to be received. The timeout logic module 306 is connected to the ACK/SACK logic module 304 to allow the ACK/SACK logic module 304 to monitor TCP/IP packet timeout status. The timeout logic module 306 has additional functions according to the present invention as described below, particularly including containing timers and retransmission logic as described below.

FIG. 3B is a logical block diagram of portions of the receiver TCP/IP interface 224 according to the preferred embodiment. It is noted that this is a logical representation and actual embodiments may implemented differently, either in hardware, software or a combination thereof. A packet buffer 352 holds a series of TCP/IP packets that have been received. As is normal practice in TCP, the packets are not removed from the buffer if there are missing packets ahead of the packet in the sequence. An ACK/SACK logic block 354 is connected to the packet buffer 352 and generates ACKs and SACKs to the IP network. The ACK/SACK logic block 354 is responsible for directing packets be removed from the packet buffer 352, such as by setting a flag so that the packet buffer 352 hardware can remove the packet. The ACK/SACK logic block 354 provides ACKs and SACKs as discussed below. The packet buffer 352 informs the ACK/SACK logic block 354 when packets have been received and when packets are missing from the order to allow the ACK/SACK logic block 354 to send ACKs and SACKs are appropriate.

Currently TCP will enter Fast Recovery when the receiver notifies the transmitter of out of sequence packets by sending duplicate acknowledgements for every out of sequence packet. The transmitter will have a threshold of the number of duplicate acknowledgements, typically three, before going into Fast Recovery to retransmit lost data. Extended Fast Recovery according to the present invention is an enhancement to the existing Fast Recovery mechanism in Standard TCP. Once in Fast Recovery, Extended Fast Recovery operation starts a timer on the retransmission of each packet. The time expires in one measured round trip time. If there has not been an acknowledgement for the retransmitted packet and the Extended Fast Recovery timer expires, it is assumed that the retransmitted packet was lost and must be retransmitted again. Extended Fast Recovery operation keeps retransmitting the packet, once every round trip time, until an acknowledgement is received or the slow recovery timer expires. The benefits to this enhancement are quick retransmission of lost packets instead of waiting for the slow recovery timer to expire or DUP ACKS or SACKs to be received. Recovering with Fast Recovery is preferred to Slow Recovery because while Fast Recovery is attempting to retransmit only the packets that are lost, new data is allowed to be transmitted because the transmit window remains open. In Slow Recovery, no new data is transmitted, only the retransmitted packets. Extended Fast Recovery operation can lead to quicker recovery on networks with high loss avoiding the need to go into Slow Recovery.

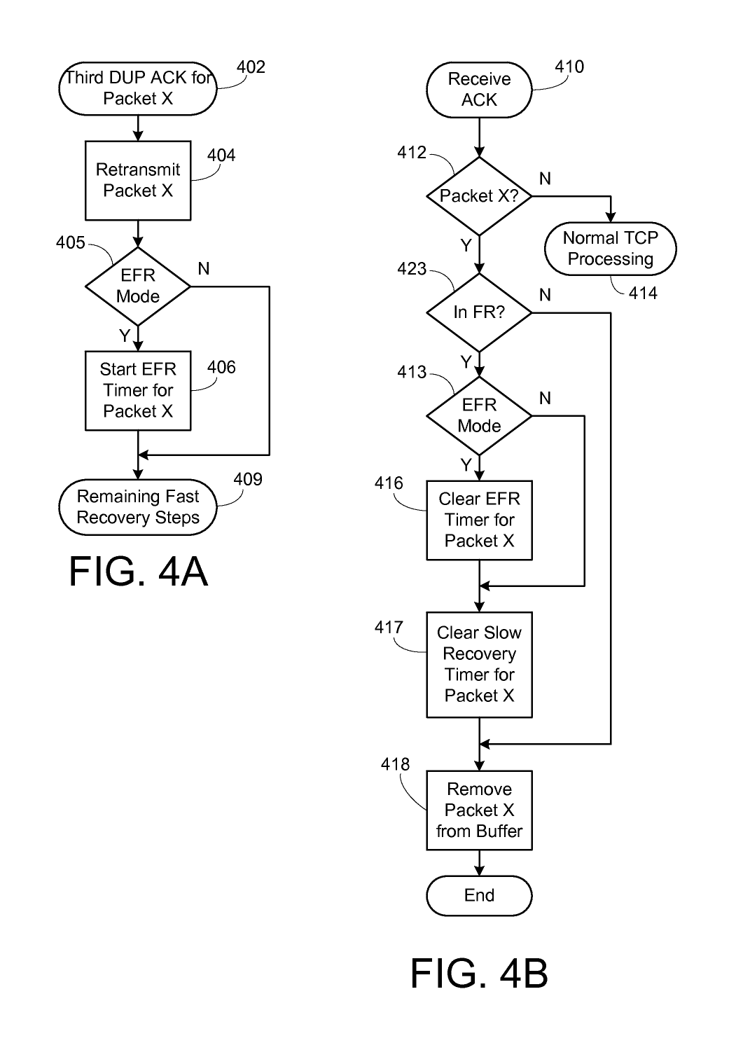

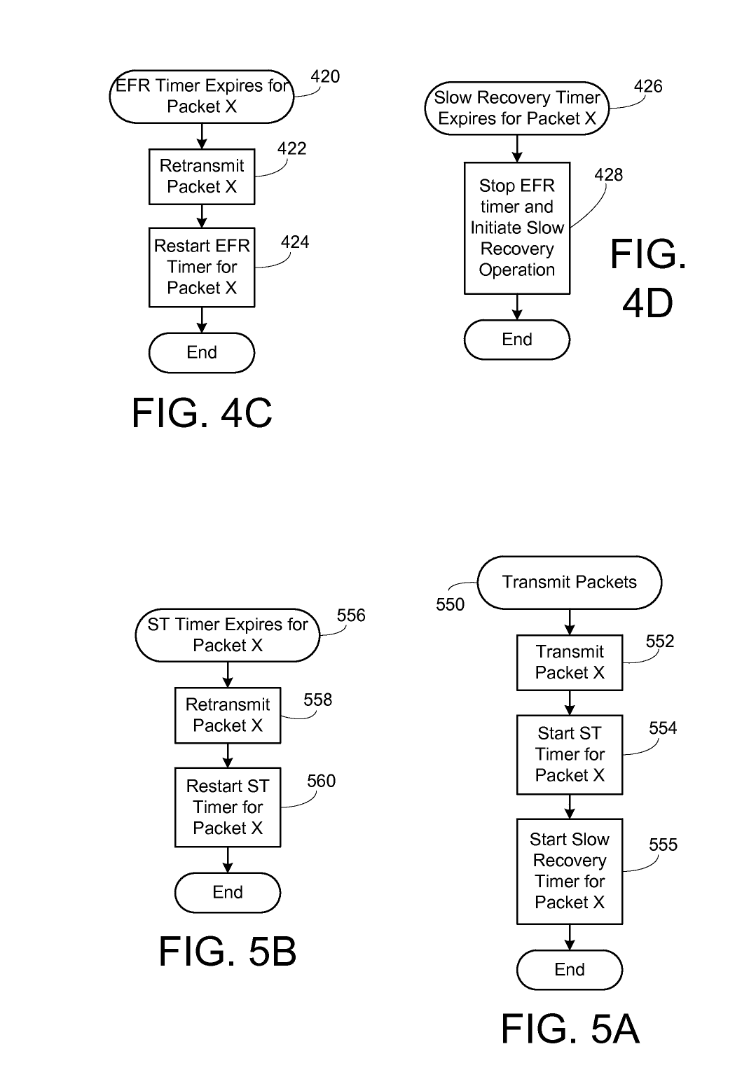

Operation of the preferred embodiment is illustrated in the flowcharts of FIGS. 4A-D. In FIG. 4A, step 402 is the entry when the third DUP ACK for packet X, the missing packet, has been received, effectively the entry into fast recovery operation. In step 404 packet X is retransmitted. In step 405 a determination of EFR mode is made. If EFR mode is invoked, in step 406 the Extended Fast Recovery (EFR) timer for packet X is started with an adjusted round trip time value, developed as discussed below. If EFR mode is not invoked or after step 406, the remaining normal fast recovery operations then occur in step 409. This sequence enables the Extended Fast Recovery timer as discussed above.

In FIG. 4B, an ACK has been received by the interface 218. In step 412 it is determined if this is an ACK for packet X. If not, normal TCP processing occurs in step 414. If the ACK is for packet X, in step 423 it is determined if fast recovery is occurring. If not, operation proceeds to step 418. If so, then in step 413 it is determined if EFR mode is invoked. If not, operation proceeds to step 417. If so, in step 416 the EFR timer is cleared. In step 417 the slow recovery timer is cleared. In step 418 packet X is removed from the packet buffer 302.

In FIG. 4C the EFR timer for packet X has expired, indicating that the ACK for packet X has not been received in the round trip time. In step 422 packet X is retransmitted again. In step 424 the EFR timer is restarted for the just retransmitted packet X to continue Extended Fast Recovery operation.

In FIG. 4D the slow recovery timer for packet X has expired. In step 428 the EFR timer is stopped, if active, and conventional slow recovery operations are initiated.

It is understood that the operations of FIGS. 4A-4D are performed for each retransferred packet where EFR operations are involved, not just a single packet. It is understood that the receiver discards any duplicate packets received without performing an ACK.

Segment Timing is an addition to Extended Fast Recovery where every sent packet is timed separately from the time of first transmission, not just retransmitted packets. If the time from first transmission has exceeded the measured round trip time a retransmission of that packet will be required. This is a more aggressive form of retransmission that does not require the fast recovery notification from the receiver to retransmit packets. It does however mean packets could be retransmitted that are not needed due to the original packet being delayed on a network longer than normal. This method is beneficial for applications that are sensitive to changes in latency due to the retransmission of lost data, because the faster the transmitter can recover from loss the better the application will perform. These types of applications can perform better even taking into account the overhead from occasional non-necessary retransmissions.

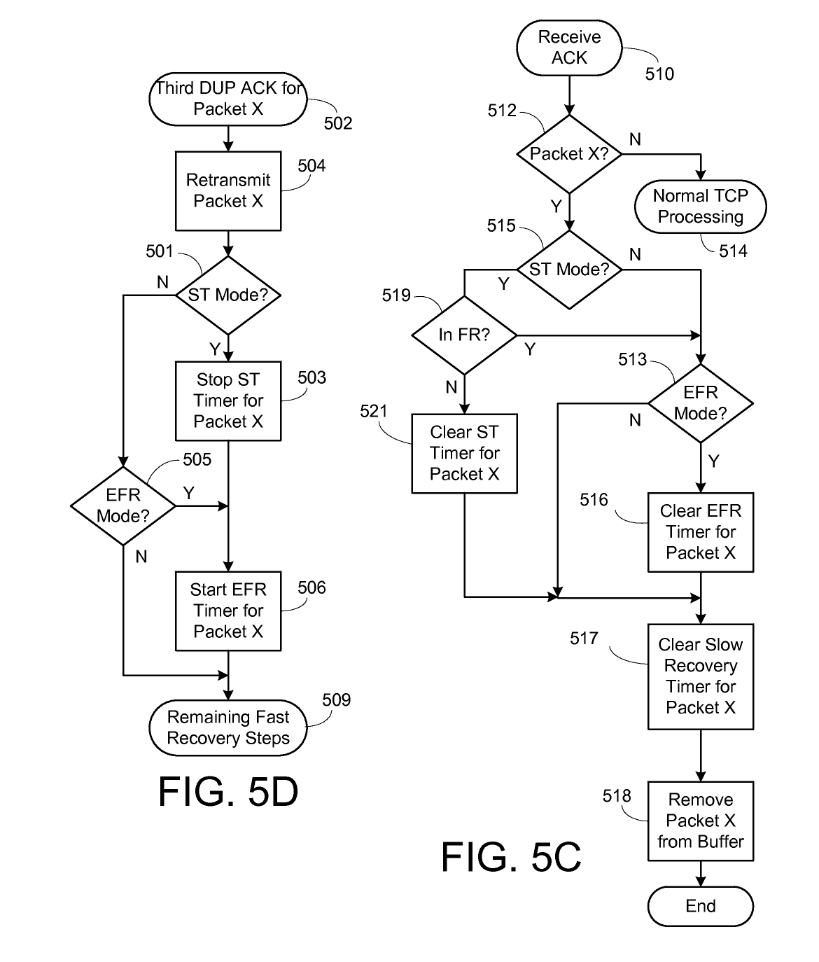

The preferred embodiment of Segment Timing for packet X is illustrated in FIGS. 5A-D, noting that preferably Segment Timing is used in conjunction with EFR. In FIG. 5A, at step 550 packets are being transmitted in normal operation. In step 552 packet X is transmitted. In step 554 the Segment Timing (ST) timer is started with the adjusted RTT value for packet X. In step 555 the slow recovery timer for packet X is started. Normal transmit operations continue. It is noted that if Segment Timing mode is invoked, Segment Timing occurs on all packets, even when in slow recovery mode.

In FIG. 5B the Segment Timing timer for packet X has expired, as shown in step 556. In step 558 packet X is retransmitted. In step 560 the Segment Timing timer is restarted.

FIG. 5C is a modified version of FIG. 4B. Like operations are numbered similarly except the values are 500 instead of 400. In step 512, if the ACK is for packet X, then in step 515 it is determined if the interface 218 is operating in Segment Timing mode. If not, operation proceeds to step 513 to determine if EFR mode is active. If so, in step 516 the EFR timer is cleared. If EFR mode is not active in step 513 or after step 516, in step 517 the slow recovery time is cleared. If Segment Timing mode is active in step 515, operation proceeds from step 515 to step 519 to determine if the transmitter is in fast recovery (FR). If so, operation proceeds to step 513. If not, in step 521 the ST timer for packet X is cleared. Operation proceeds to step 517 to clear the slow recovery timer as it relates to packet X. In step 518 packet X is removed from the packet buffer 302.

FIG. 5D is a modified version of FIG. 4A. Like operations are numbered similarly except the values are 500 instead of 400. After packet X is retransmitted in step 504, in step 501 a determination of ST mode is made. If ST mode is active, in step 503 the ST timer for packet X is stopped so that packet X moves from segment timing mode to extended fast recovery operation. If not in ST mode, then in step 505 a determination is made if EFR mode is invoked. If so, and after step 503, step 506 is executed. If EFR mode is not invoked or after step 506, in step 509 the remaining fast recovery steps are performed.

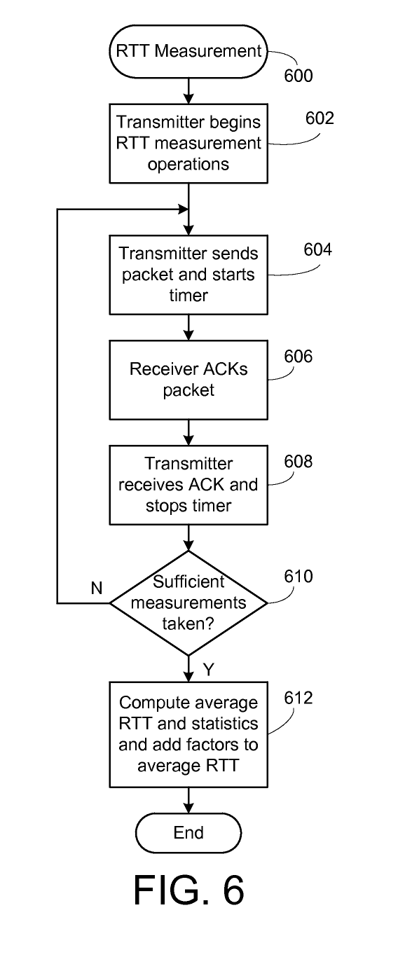

In FIG. 6 an exemplary measurement of round trip time is illustrated. It is understood that there are numerous ways to measure RTT and this is just one example. In step 602 the transmitter, such as interface 218, begins RTT measurement operations. In step 604 the transmitter sends a known packet and starts a timer. In step 606 the receiver ACKs the packet. In step 608 the transmitter receives the ACK and stops the timer, the timer value being the RTT for that particular instance. It is understood that a particular ACK may be delayed for numerous reasons, so in the preferred embodiment packets that are the least likely to be delayed are chosen, such as the last packet in a sequence and the like. In step 610 a determination is made if enough RTT samples have been obtained. As there are many possible ways that individual packet times can vary, it is preferred to take a number of samples and determine statistics from those samples. If not enough samples, operation returns to step 604. If enough samples have been obtained, in step 612 the transmitter determines the average RTT value and various other statistics, such as variance and the like. Using the average and the statistics and a known internal delay value, an adjusted RTT value to be used in the EFR and ST timers is obtained. As this value is higher than the expected actual RTT, slight variances in return time for a given packet due to routing differences, delayed ACKs and the like are compensated for.

While separate ST and EFR timers are described, it is understood that a single timer can be used for both operations, with the possible addition of a flag to indicate ST or EFR use.

It is also understood that the flowcharts are a simplification of any actual embodiment and are provided to simplify operation according to the present invention. It is further understood that the flowchart operations can be performed by hardware logic, a processor and firmware or software or a combination.

By retransmitting a packet after just an RTT without receiving an ACK, either for the original transmission or for a fast recovery retransmission, packets can be provided to the receiver earlier than if waiting for fast recovery or slow recovery operations to be started and hopefully avoids entry into slow recovery and its great slowdown of effective data transfer.

The above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A transmission control protocol (TCP) transmitter comprising:
a port for receiving and transmitting TCP packets;
a timer configured to time an adjusted round trip time for a transmitted packet; and
retransmit logic coupled to said timer and said port for providing a packet for retransmission if said timer expires before an ACK is received for the packet.

2. The TCP transmitter of claim 1, wherein said timer operates only for retransmitted packets.

3. The TCP transmitter of claim 2, wherein said timer operation commences after the TCP transmitter starts fast recovery operation.

4. The TCP transmitter of claim 2, wherein said timer operation commences after the TCP transmitter receives three DUP ACKs for the packet.

5. The TCP transmitter of claim 1, wherein said timer operates for all transmitted and retransmitted packets.

6. A method comprising:
receiving and transmitting transmission control protocol (TCP) packets;
timing an adjusted round trip time for a transmitted packet; and
providing a packet for retransmission if the adjusted round trip time expires before an ACK is received for the packet.

7. The method of claim 6, wherein said timing operates only for retransmitted packets.

8. The method of claim 7, wherein said timing operation commences after the start of fast recovery operation.

9. The method of claim 7, wherein said timing operation commences after the receipt of three DUP ACKs for the packet.

10. The method of claim 6, wherein said timing operates for all transmitted and retransmitted packets.
